(19) United States
(12) Patent Application Publication
(10) Pub. No.: US 2026/0261336 A1
(43) Pub. Date: Sep. 3, 2026

(54) ANGULAR HOPPING METHOD FOR INITIAL SEARCHES IN GEOSYNCHRONOUS EARTH ORBIT SYSTEMS

(71) Applicant: YTTEK Technology Corp., Zhubei City (TW)

(72) Inventor: CHUNG-LIEN HO, Zhubei City (TW)

(21) Appl. No.: 19/390,833

(22) Filed: Nov. 17, 2025

Related U.S. Application Data
(60) Provisional application No. 63/765,449, filed on Feb. 28, 2025.

(51) Int. Cl. H04B 7/19

(52) U.S. Cl. CPC H04B 7/19

(57) ABSTRACT

The present invention discloses an angular hopping method for initial searches in Geosynchronous Earth Orbit (GEO) systems, comprising spatial decoupling, multi-stage peak location detection (MSPLD), and angular hopping. The spatial decoupling divides a joint/full three-dimensional (3D) search space into a decoupled search space and a retrograded search space. The multi-stage peak location detection assigns a peak location in the decoupled search space for rapid positioning. The angular hopping iteratively refines the assigned peak location by applying angular displacements with random signs, thereby progressively refining the peak location and avoiding power dead-zone issues. When the beamforming output power falls below a minimum power requirement, the multi-stage peak location detection is re-executed to ensure link alignment.

This application claims the priority benefit of provisional patent application No. 63/765,449 titled “ANGULAR HOPPING METHOD FOR INITIAL SEARCHES IN GEOSYNCHRONOUS EARTH ORBIT SYSTEMS” filed on 28 Feb. 2025, the disclosure of which is incorporated by reference herein in its entirety.

### BACKGROUND OF THE INVENTION

### Field of Invention

The present invention relates to satellite communications, and more particularly to an angular hopping method for initial searches in Geosynchronous Earth Orbit (GEO) systems.

### Description of the Related Art

Satellite communication involves the transmission of signals via electromagnetic beams between user terminals (UTs) located on the Earth's surface and target satellites in orbit. The UT may include either fixed communication equipment or mobile communication equipment, with the latter installed on movable platforms such as ships and vehicles. To ensure accurate link transmission, each UT must align its beams with a corresponding target satellite.

The UT achieve accurate link transmission by using beam directivity to focus the transmitted signals toward the target satellite. When the UT is in motion, the mobile UT must search for the target satellite in the Geosynchronous Earth Orbit (GEO) and accordingly adjust its beam alignment.

### SUMMARY OF THE INVENTION

The main purpose of the present invention is to provide an angular hopping method for initial searches in Geosynchronous Earth Orbit (GEO) systems.

In order to achieve the aforementioned purpose, the present invention employs the following technical solution:

An angular hopping method for initial searches in Geosynchronous Earth Orbit (GEO) systems is performed prior to a multi-stage peak location detection (MSPLD) process for separate search spaces when a beamforming output power does not satisfy minimum power requirements during an initial search phase.

The angular hopping method for initial searches in Geosynchronous Earth Orbit (GEO) systems comprises the following steps:

### Spatial Decoupling:

Decomposing a joint/full three-dimensional (3D) search space into a decoupled search space (first search space) and a retrograded search space (second search space), wherein the decoupled search space comprises a one-dimensional (1D) search space with relatively low spatial selectivity, which is decoupled from the joint/full three-dimensional (3D) search space, and the retrograded search space comprises a remaining two-dimensional (2D) joint space after the spatial decoupling of the original joint/full three-dimensional (3D) search space.

### Multi-Stage Peak Location Detection (MSPLD):

At the start of each stage of the multi-stage peak location detection (MSPLD), assigning a peak location (PL) in the decoupled search space (first search space).

### Angular Hopping:

Iteratively refining the pre-assigned peak location (PL) by applying a random-sign decreasing displacement distance (i.e., angular displacement) within the decoupled search space.

Wherein, when the beamforming output power is less than the minimum power requirement of the initial search phase, the MSPLD is re-executed.

By performing spatial decoupling on the joint/full three-dimensional (3D) search space, separating a one-dimensional (1D) search space with relatively low spatial selectivity as the decoupled search space and using the remaining two-dimensional (2D) space as the retrograded search space, the present invention effectively reduces the search dimension and the total number of candidate point detections, thereby decreasing computational complexity and overall search time.

Consequently, the method can achieve improved system performance with as few as two angular hopping processes.

### BRIEF DESCRIPTION OF THE DRAWINGS

FIG. 1 shows an estimate of mechanical antenna orientation in a three-dimensional (3D) search space.

FIG. 2 shows the definition of antenna orientation in a three-dimensional (3D) space.

FIG. 3 shows a search candidate set V₃ in a third search direction ϑ₃.

FIG. 4 shows a spatial decoupling mechanism of the present invention.

FIG. 5 shows a multi-stage peak location detection (MSPLD) mechanism of the present invention.

FIG. 6 shows a beamforming output power profile along a slant (γ) axis.

FIG. 7 shows an angular hopping of the present invention.

FIG. 8 shows a three-dimensional (3D) beamforming output power profile with a resolution of 1° along a bearing (α) axis and a down-tilt (β) axis.

FIG. 9 shows a three-dimensional (3D) beamforming output power profile with a resolution of 3° along the bearing (α) axis and the down-tilt (β) axis.

FIG. 10 shows a three-dimensional (3D) beamforming output power profile with a resolution of 10° along the bearing (α) axis and the down-tilt (β) axis.

FIG. 11 shows peak location detection in a power dead-zone condition.

FIG. 12 shows a beamforming output power profile along a slant (γ) axis.

FIG. 13 shows an angular hopping process for addressing the power dead-zone issue.

FIG. 14 shows a correspondence between FIG. 14A and FIG. 14B.

FIG. 14A is part A of FIG. 14 and shows a beamforming output power profile along the slant (γ) axis without angular hopping.

FIG. 14B is part B of FIG. 14 and shows a beamforming output power profile along the slant (γ) axis with angular hopping.

FIG. 15 shows a beamforming output power profile along the slant (γ) axis without angular hopping.

FIG. 16 shows the number of re-guess processes in the angular hopping process.

FIG. 17 shows an angle displacement of a slant angle (γ) and a final re-guess result in the angular hopping process.

FIG. 18 shows a random-guess initial sign and a final sign of the slant angle (γ) in the angular hopping process.

FIG. 19 shows the procedures of multi-stage peak location detection (MSPLD) in the angular hopping process.

FIG. 20 shows an algorithm of the angular hopping process.

FIG. 21 shows a flowchart of the angular hopping process.

FIG. 22 shows an illustration of array index mapping.

### DETAILED DESCRIPTION OF THE PREFERRED EMBODIMENTS

The accompanying drawings illustrate embodiments of spatial decoupling for initial searches in Geosynchronous Earth Orbit (GEO) systems in accordance with the present invention. These drawings are provided solely for illustrative purposes and are not intended to limit the scope of the invention.

An optimal search for a three-dimensional (3D) joint space through a full-angle/global search corresponds to three-dimensional main beam acquisition, which is a brute-force (exhaustive) blind search (scanning) mechanism. This method can probe one axis at a time or alternate between the three axes. It is a simple and low-cost approach; however, it is time-consuming. The performance of this brute-force mechanism depends on the step size and/or the signal-to-noise ratio (SNR), and it requires no prior information. A two-stage strategy for a uniform exhaustive search involves using a fixed and relatively large step-size for large-scale probing in a first stage, followed by small-scale probing in a second stage. The second stage uses a fixed and relatively small step-size around the search points determined in the first stage. The search stop condition is satisfied when the pointing error is within a 3 dB beamwidth, thereby achieving the minimum link level required for alignment (e.g., for control signaling), such that: Pᵣₓ≥Pₘᵢₙ≈P_{3 dB}.

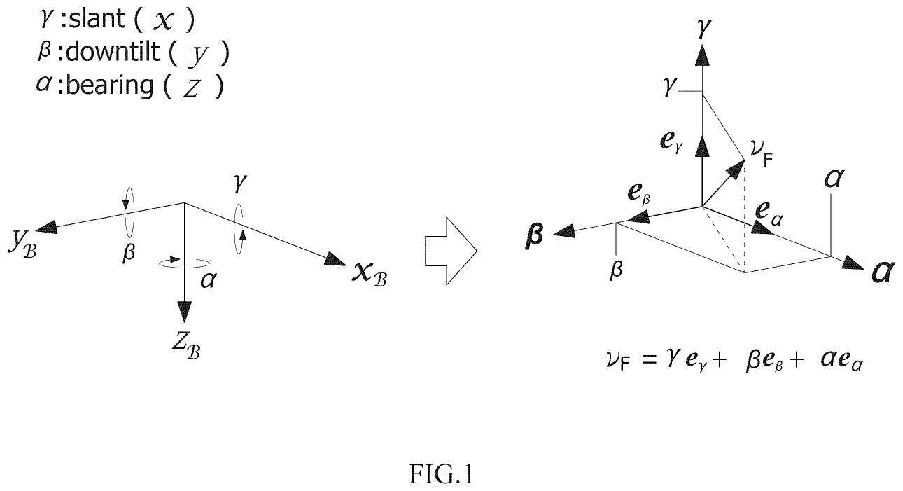

As shown in FIG. 1, the issue with the brute-force mechanism (i.e., exhaustive linear or uniform search) lies in the exhaustive peak location detection (PLD) of a receive (Rx) beamforming (BF) output. The objective function is the receive (Rx) beamforming output power, which is a function of the antenna direction (i.e., controlled by (γ,β,α)), and is represented as a triple-variable function: g=f_{γβα}(γ,β,α)≡g_{γβα}. The goal is to determine the antenna direction (γ,β,α) that maximizes the receive (Rx) beamforming output power g. A peak location (PL) in the three-dimensional (3D) joint search space, which is spanned by the three-dimensional (3D) orthonormal standard bases (e_{γ}, e_{β}, e_{α}), can be estimated by the corresponding direction (γ,β,α) obtained from measurements of a joint objective function g_{F} in the full three-dimensional (3D) search space, where:

$${g}_{F} ≡ {g}_{γ β α} = {f}_{γ β α} ( γ , β , α ) .$$

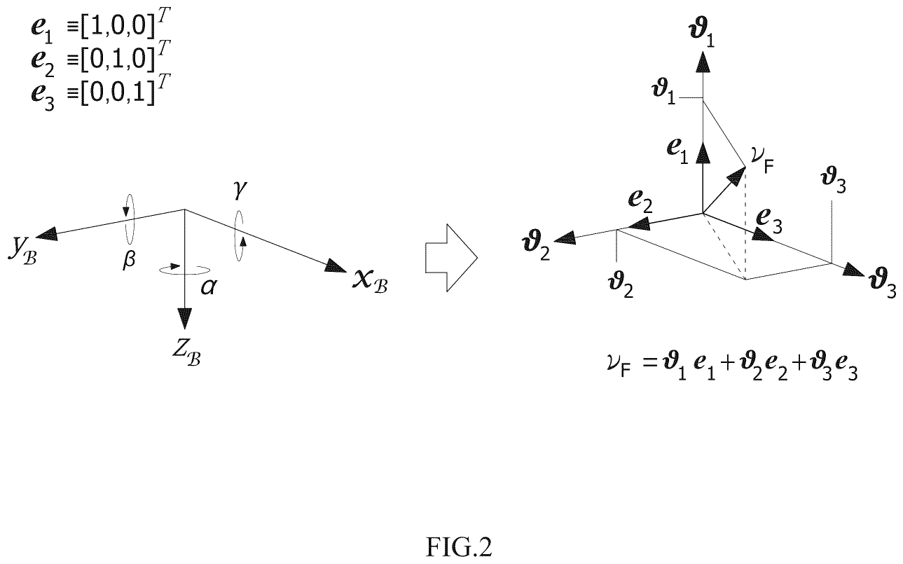

As shown in FIG. 2, a uniform peak location detection (PLD) is performed across all possible search candidates (set) V_{F} in the joint/full three-dimensional (3D) search space [symbol] _{F}. The term ‘uniform’ in this context refers to a uniformly distributed set of search candidates defined by a specified start position and step-size. The joint/full three-dimensional (3D) search space [symbol] _{F} is mathematically expressed as:

$${𝒮}_{F} ≡ Span \{ {e}_{1} , {e}_{2} , {e}_{3} \} = \{ {ϑ}_{1} {e}_{1} + {ϑ}_{2} {e}_{2} + {ϑ}_{3} {e}_{3} \vert {ϑ}_{i} ∈ ℝ \} ∈ {ℝ}^{3} ,$$

$$\text{where:}$$

$${e}_{1} ≡ {[ 1 , 0 , 0 ]}^{T} , {e}_{2} ≡ {[ 0 , 1 , 0 ]}^{T} , {e}_{3} ≡ {[ 0 , 0 , 1 ]}^{T} ,$$

[symbol] _{F} represents the joint/full (3D, D_{F}=3) search space,
eᵢ∈ [symbol] ³ denotes an i^{th} orthonormal basis (specifying the i^{th} search direction ϑᵢ) in [symbol] _{F}, and
ϑᵢ represents a coefficient of the i^{th} standard basis (specifying the i^{th} search position).

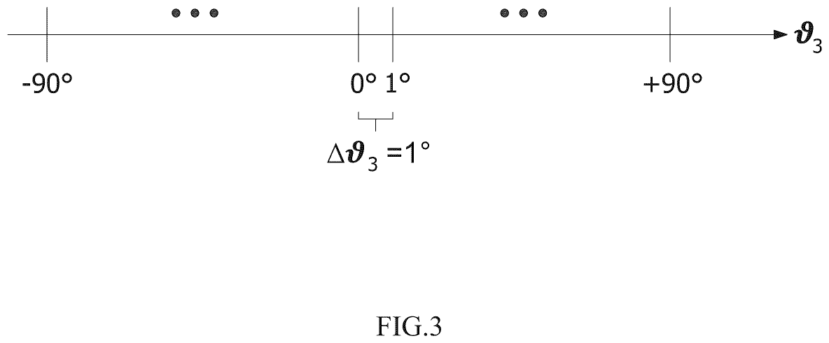

As shown in FIG. 3, a uniform (linear) search is defined as follows:

$${V}_{F} ≡ \{ \tilde{ϑ} \} ∈ {ℝ}^{3} ,$$

where V_{F} represents the uniform search set containing total N_{F} possible candidates {\tilde{ϑ}}ₗ, l=1, . . . , N_{F}.

Each candidate is expressed as:

$${\{ \tilde{ϑ} \}}_{l} ≡ {[ {\{ {\tilde{ϑ}}_{1} \}}_{{l}_{1}} , {\{ {\tilde{ϑ}}_{2} \}}_{{l}_{2}} , {\{ {\tilde{ϑ}}_{3} \}}_{{l}_{3}} ]}^{T} ∈ {ℝ}^{3} ,$$

where l=map((j₁,j₂,j₃))=1, . . . , N_{F}.

For the i^{th} search direction ϑᵢ:

$${V}_{i} ≡ \{ {\tilde{ϑ}}_{i} \} ∈ {ℝ}^{1} ,$$

where Vᵢ is the uniform search set containing Nᵢ candidates {\tilde{ϑ}ᵢ}ₗ_{ᵢ}∈ [symbol] ¹, lᵢ=1, . . . Nᵢ, along the i^{th} search direction ϑᵢ.

### Search Parameters:

Search range: Along the i^{th} search direction ϑᵢ, the range is determined by the field of view (FoV) Θᵢ:

$${Θ}_{i , min} \leq {\tilde{ϑ}}_{i} , {\tilde{ϑ}}_{i} \leq {Θ}_{i , max} , {Θ}_{i} ≡ {Θ}_{i , max} - {Θ}_{i , min} .$$

Step-size: The constant step size (i.e., search spacing) along the i^{th} search direction ϑᵢ is denoted as Δϑᵢ.

Number of candidates: The number of candidates (i.e., size of search set) Nᵢ along the i^{th} search direction ϑᵢ is given by:

$${N}_{i} ≡ L ( {V}_{i} ) = L ( \{ {\tilde{ϑ}}_{i} \} ) = ⌈ \frac{{Θ}_{i}}{{Δϑ}_{i}} ⌉ .$$

Specifically, FIG. 3 shows the search candidate set V₃ in the third search direction ϑ₃, where the search range is Θ₃=180°, the step size is Δϑ₃=1°, and thus the number of candidate points is: N₃≡┌Θ₃/ϑ₃┐=180, with the search range extending from −90° to +90°.

The total number of overall candidates (i.e., the overall search number) N_{C} in the joint/full three-dimensional (3D) search space [symbol] _{F} is given by:

$${N}_{C} ≡ L ( {V}_{F} ) = L ( \{ \tilde{ϑ} \} ) = {\prod }_{i = 1}^{{D}_{F} = 3} {N}_{i} = {N}_{1} {N}_{2} {N}_{3} ,$$

For example, if {\tilde{ϑ}}∈ [symbol] ², and Nᵢ=2, N₂=3, i=1,2, N_{F}=N₁N₂=6, the candidate set {\tilde{ϑ}} can then be expressed as:

$$\{ \tilde{ϑ} \} = \{ {\underbrace{[ \begin{matrix}{\{ {ϑ}_{1} \}}_{1} \\ {\{ {ϑ}_{2} \}}_{1}\end{matrix} ]}}_{l = 1 : {\{ \tilde{ϑ} \}}_{1}} , {\underbrace{[ \begin{matrix}{\{ {ϑ}_{1} \}}_{1} \\ {\{ {ϑ}_{2} \}}_{2}\end{matrix} ]}}_{l = 2 : {\{ \tilde{ϑ} \}}_{2}} , {\underbrace{[ \begin{matrix}{\{ {ϑ}_{1} \}}_{1} \\ {\{ {ϑ}_{2} \}}_{3}\end{matrix} ]}}_{l = 3 : {\{ \tilde{ϑ} \}}_{3}} , {\underbrace{[ \begin{matrix}{\{ {ϑ}_{1} \}}_{2} \\ {\{ {ϑ}_{2} \}}_{1}\end{matrix} ]}}_{l = 4 : {\{ \tilde{ϑ} \}}_{4}} , {\underbrace{[ \begin{matrix}{\{ {ϑ}_{1} \}}_{2} \\ {\{ {ϑ}_{2} \}}_{2}\end{matrix} ]}}_{l = 5 : {\{ \tilde{ϑ} \}}_{5}} , {\underbrace{[ \begin{matrix}{\{ {ϑ}_{1} \}}_{2} \\ {\{ {ϑ}_{2} \}}_{3}\end{matrix} ]}}_{l = 6 : {\{ \tilde{ϑ} \}}_{6}} \}$$

That is, the total number of candidate points is the Cartesian product of the number of candidates in each search direction.

Accordingly, the overall search number in the joint/full three-dimensional (3D) search space S_{F} is calculated as:

$${N}_{C} = {N}_{1} {N}_{2} {N}_{3}$$

Example 1: If Θ₁=180°, Θ₂=90°, Θ₃=360°, and Δϑ₁=Δϑ₂=Δϑ₃=1°, then N_{C}=180×90×360=5,832×10³.

Example 2: If Θ₁=180°, Θ₂=90°, Θ₃=360°, and Δϑ₁=Δϑ₂=Δϑ₃=3° (where the 3-dB beamwidth in bearing/down-tilt is approximately BW_{3 dB}=3.16° for a 32-element array), then N_{C}=60×30×120=216×10³.

While the brute-force solution for mechanical antenna orientation mechanisms is conceptually simple and theoretically optimal, the substantial number of required searches results in significant computational time consumption and mechanical wear-and-tear issues.

A sub-optimal solution is therefore proposed by using a spatial decoupling technique to reduce the dimensionality of the search space. In general, K=2 separate search spaces can be constructed to decrease the number of searches. A multi-stage peak location detection (MSPLD) (typically Q=2 stages are sufficient) using successively decreasing search step-size is further introduced to reduce computational complexity and accelerate decision-making. Additionally, an angular hopping process (typically P=2 hopping iterations) can be applied to avoid power dead zones during the peak location detection (PLD), thereby enhancing overall system performance. The aforementioned K represents the number of lower-dimensional search spaces formed by decoupling, Q represents the number of stages of the multi-stage peak location detection, and P represents the number of hopping iterations in the angular hopping process.

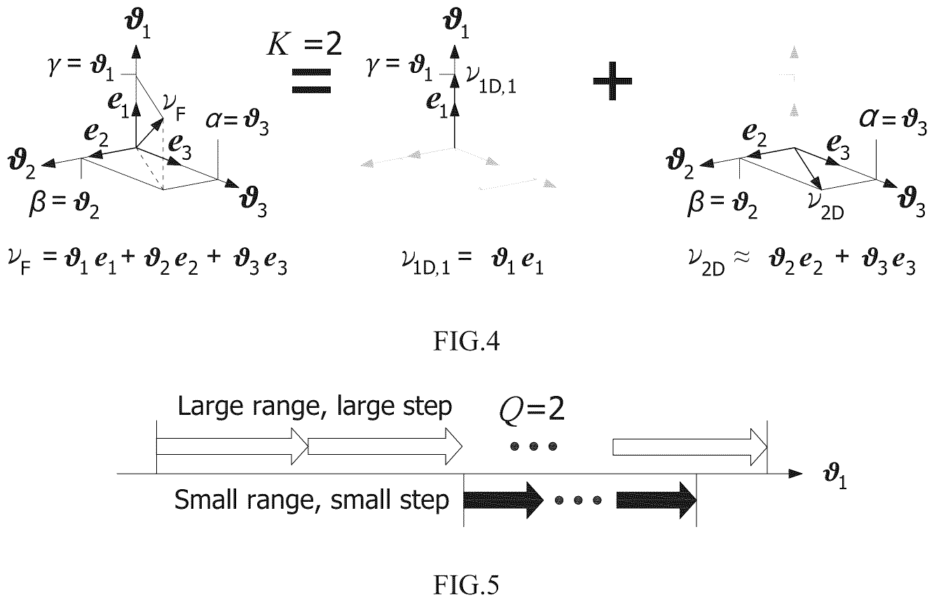

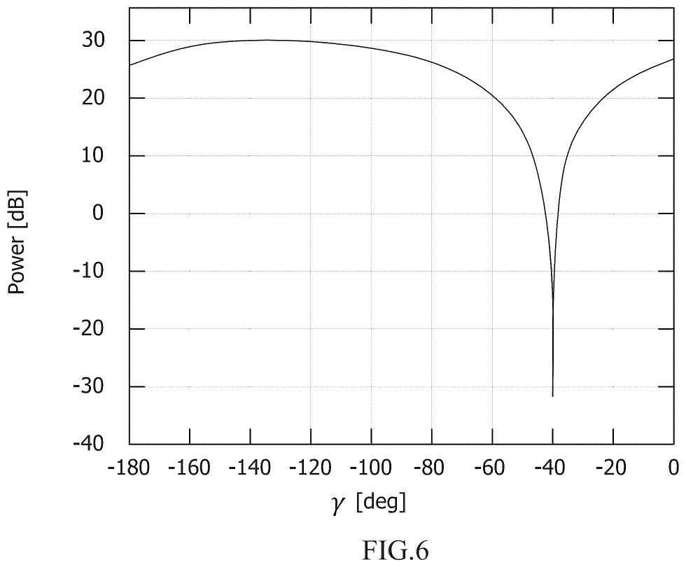

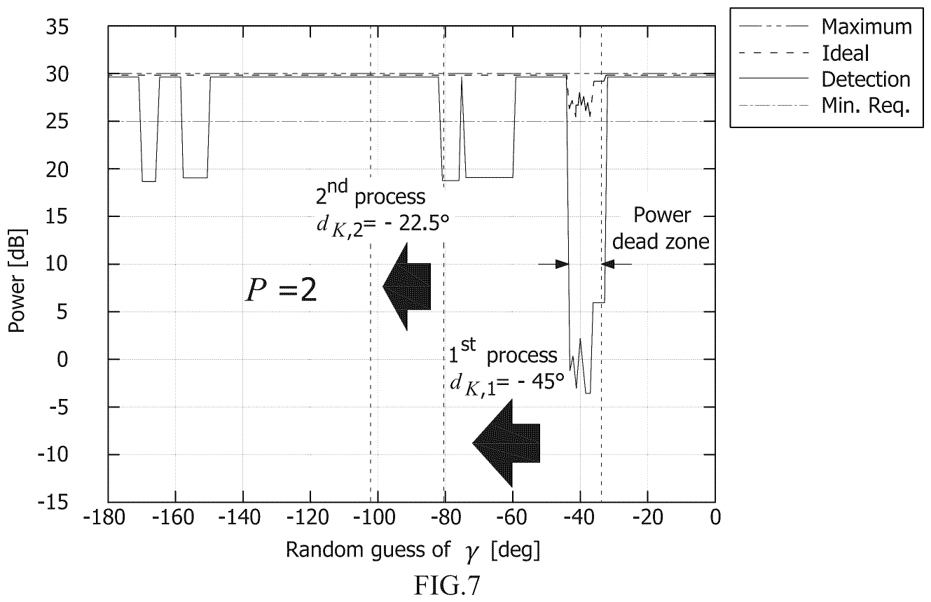

As shown in FIGS. 4 through 7, the proposed sub-optimal solution for the initial search in a Geosynchronous Earth Orbit (GEO) system during a cold-start phase includes the following key operations: (1) Spatial decoupling for reducing the dimensionality of the search space; (2) Multi-stage peak location detection (MSPLD) for accelerating processing time; and (3) Angular hopping of the peak location for avoiding the power dead-zone issues.

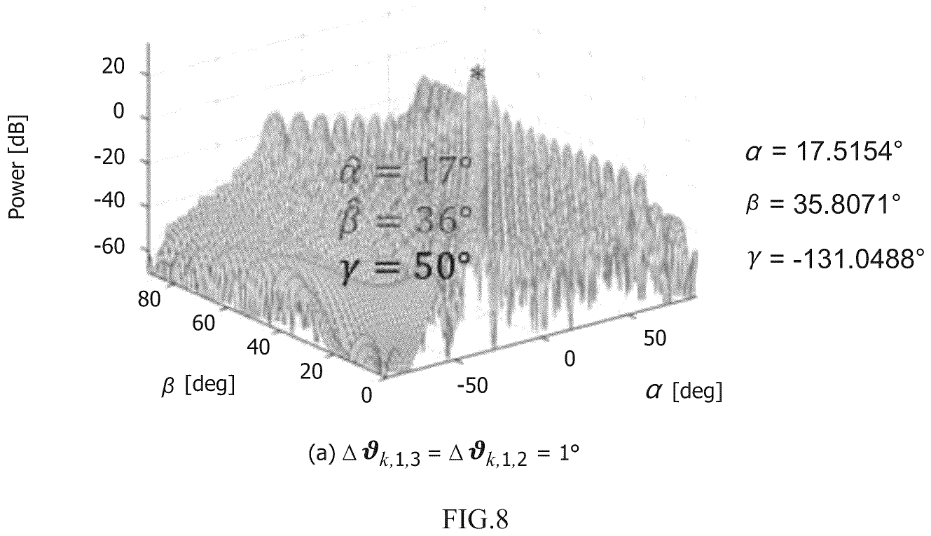

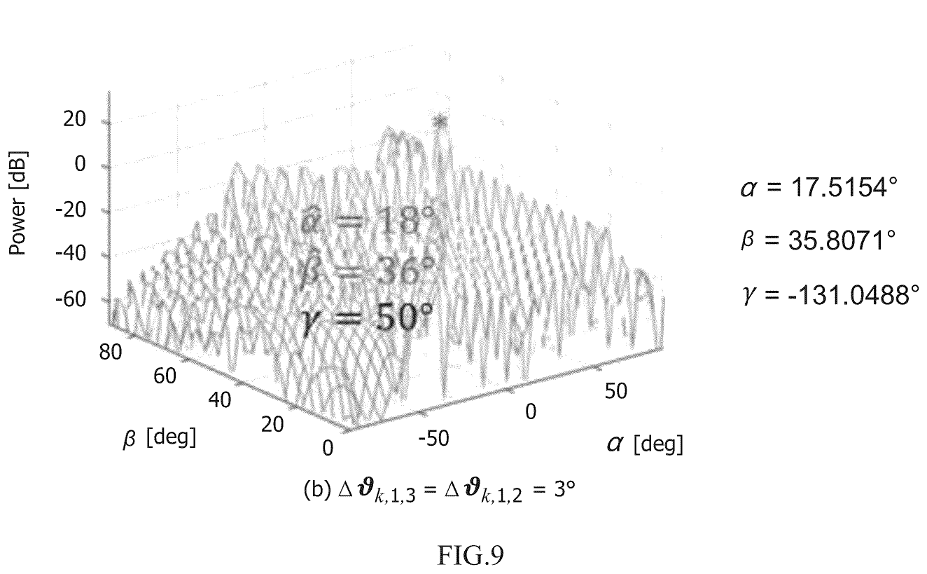

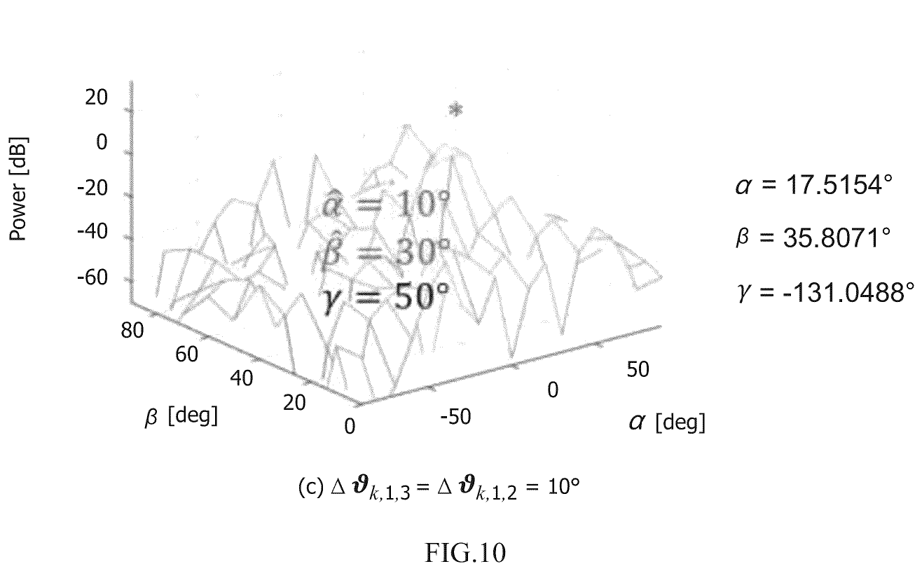

As shown in FIGS. 8 to 10, Example 3 demonstrates a two-stage peak location detection (PLD) process applied to two separate search spaces: a retrograded search space [symbol] _{D,1}, spanned by e₂ and e₃, and a decoupled search space [symbol] _{D,2}, spanned by e₁. The decoupled search space includes a one-dimensional (1D) search space with relatively low spatial selectivity that is decoupled from the joint/full three-dimensional (3D) search space [symbol] _{F}, and the retrograded search space [symbol] _{D,1} includes the two-dimensional (2D) joint search space remaining after spatial decoupling of the joint/full three-dimensional (3D) search space. In the first stage, a large-scale global (full-angle) search is performed within the retrograded search space [symbol] _{D,1} and the decoupled search space [symbol] _{D,2}, utilizing a large region Θ_{k,1,i}_{ₖ}: for example, Θ_{k,1,1}=180°, Θ_{k,1,2}=90°, Θ_{k,1,3}=360°, with a fixed and relatively large step-size Δϑ_{k,1,i}_{ₖ}: for example, Δϑ_{k,1,1}=Δϑ_{k,1,2}=Δϑ_{k,1,3}=100. In the second stage, a small-scale local (partial-angle) search is performed within the retrograded search space [symbol] _{D,1} and the decoupled search space [symbol] _{D,2}, utilizing a small region Θ_{k,2,i}_{ₖ}: for example, Θ_{k,2,1}=2Δϑ_{k,1,1}, Θ_{k,2,2}=2Δϑ_{k,1,2}, Θ_{k,2,3}=2Δϑ_{k,1,3} where the region is one-half the step-size of the first stage, along with a fixed and relatively small step-size Δϑ_{k,2,i}_{ₖ}: for example, Δϑ_{k,2,1}=Δϑ_{k,2,2}=Δϑ_{k,2,3}=3°.

The total number of candidate point detections required in the multi-stage peak location detection process is calculated as follows:

$${N}_{C} = {\sum }_{k = 1}^{K} {N}_{D , k} = {\sum }_{k = 1}^{K} {\underbrace{{\sum }_{q = 1}^{{Q}_{k}} {N}_{D , k , q}}}_{{N}_{D , k}} = {\sum }_{k = 1}^{K} {\sum }_{q = 1}^{{Q}_{k}} {\underbrace{{\prod }_{{i}_{k}}^{{D}_{k}} {N}_{k , q , {i}_{k}}}}_{{N}_{D , k , q}}$$

Here, N_{D,k} represents the search number of k^{th} separate space [symbol] _{D,k}; N_{D,k,q} represents the search number in the q^{th} stage of the k^{th} separate space [symbol] _{D,k}; and N_{k,q,i}_{ₖ} represents the number of searches along the iₖ^{th} search direction with a scanning region Θ_{k,q,i}_{ₖ} and a step-size Δϑ_{k,q,i}_{ₖ} in the q^{th} stage of the k^{th} separate space [symbol] _{D,k}.

Example 4: If the joint/full three-dimensional (3D) search space [symbol] _{F} is decomposed into the retrograded search space [symbol] _{D,1} and the decoupled search space [symbol] _{D,2}, then the overall search number using the two-stage peak location detection (PLD) is determined as follows:
For the retrograded search space [symbol] _{D,1} (k=1):

$${N}_{D , 1} = {N}_{D , 1 , 1} + {N}_{D , 1 , 2} = ( {N}_{1 , 1 , 1} {N}_{1 , 1 , 2} ) + ( {N}_{1 , 2 , 1} {N}_{1 , 2 , 2} ) .$$

For the decoupled search space [symbol] _{D,2} (k=2):

$${N}_{D , 2} = {N}_{D , 2 , 1} + {N}_{D , 2 , 2} = ( {N}_{2 , 1 , 1} ) + ( {N}_{2 , 2 , 1} ) .$$

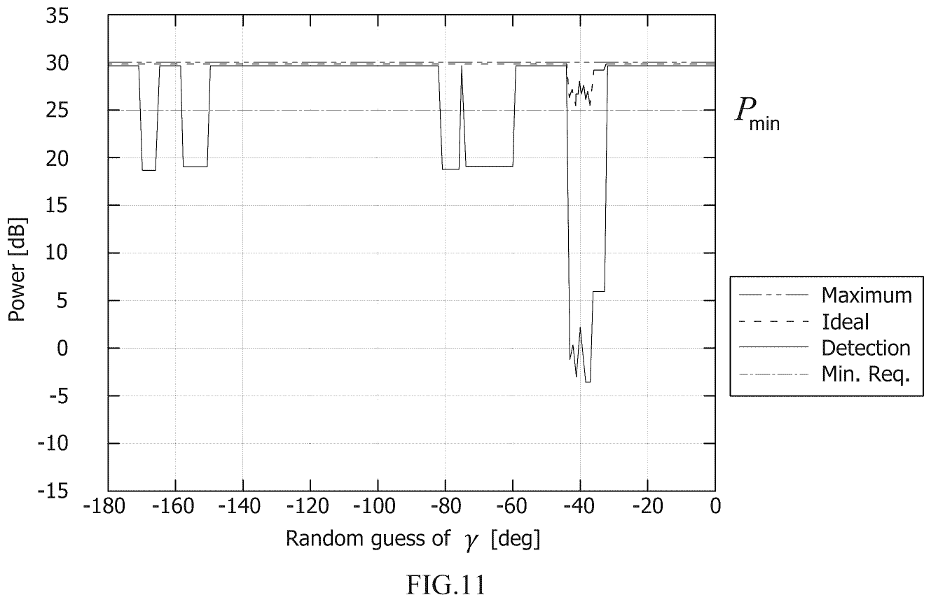

As shown in FIG. 11, the angular hopping of the peak location resolves the power dead-zone problem. The judgment condition for the hopping process is defined as follows: If the measured beamforming (BF) output power P̅ₚ is less than the minimum power requirement Pₘᵢₙ (i.e., P̅ₚ<Pₘᵢₙ) during the p^{th} hopping process, then the peak location detection must be re-executed. The minimum power requirement Pₘᵢₙ is defined as a threshold corresponding to the beamforming output power required to establish link alignment.

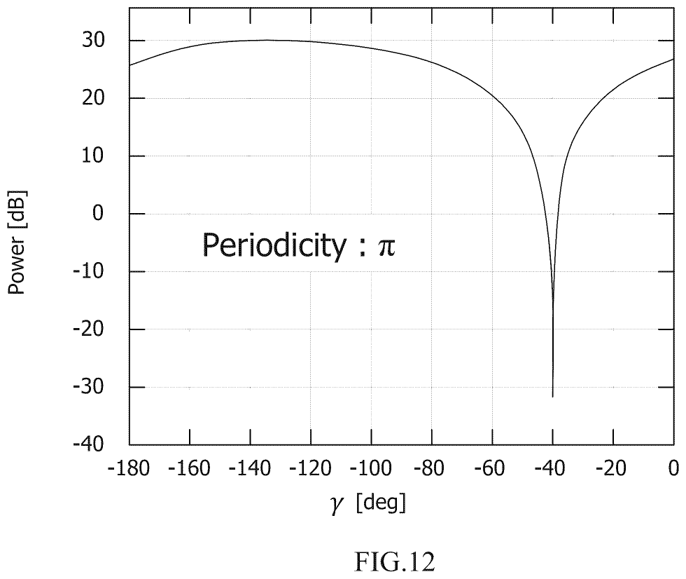

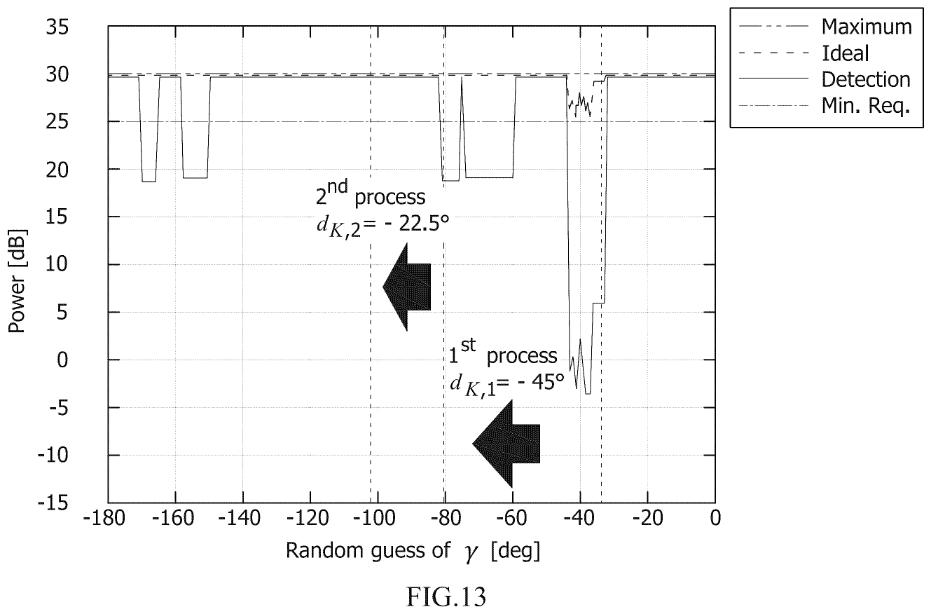

As shown in FIGS. 12 and 13, the proposed solution involves reassigning a new pre-determined peak location in the decoupled search space, assuming the K^{th} separate space [symbol] _{D,K}∈ [symbol] ¹. Theoretically, this reassignment can be performed at the start of any stage in any search space during the peak location detection (PLD) process. However, to achieve higher accuracy in the peak location detection (PLD) with increased measurement power and only minimal additional computation, it is recommended to perform the reassignment at the start of all stages across all search spaces. Under a random guessing mechanism, the preset peak location can be iteratively refined through angular displacement, where the angular displacement is iteratively corrected with a decreasing displacement distance of random signs. The angular displacement d_{K,p} from the current selected location during the p^{th} process of a total of N_{reguess}=P re-guess process is expressed as:

$${d}_{K , p} = \pm \frac{π}{μ p} ∈ {Θ}_{K , 1} ,$$

μ=2 or 4, μ=1, . . . , P. In general, P≤2 is sufficient for effective refinement.

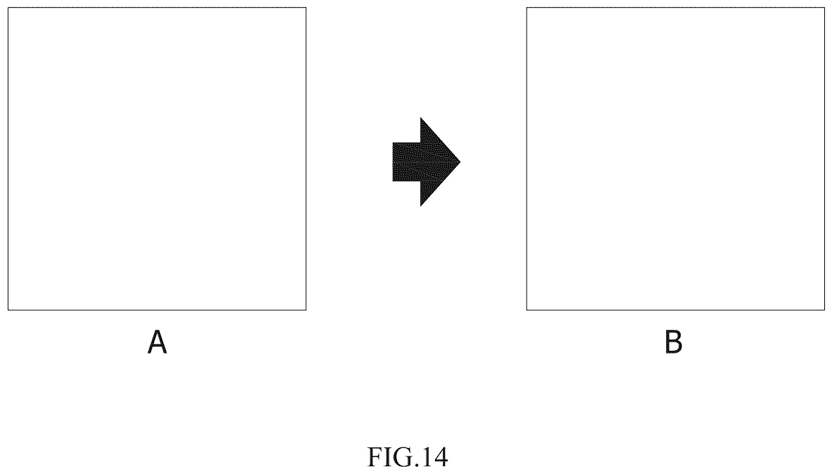

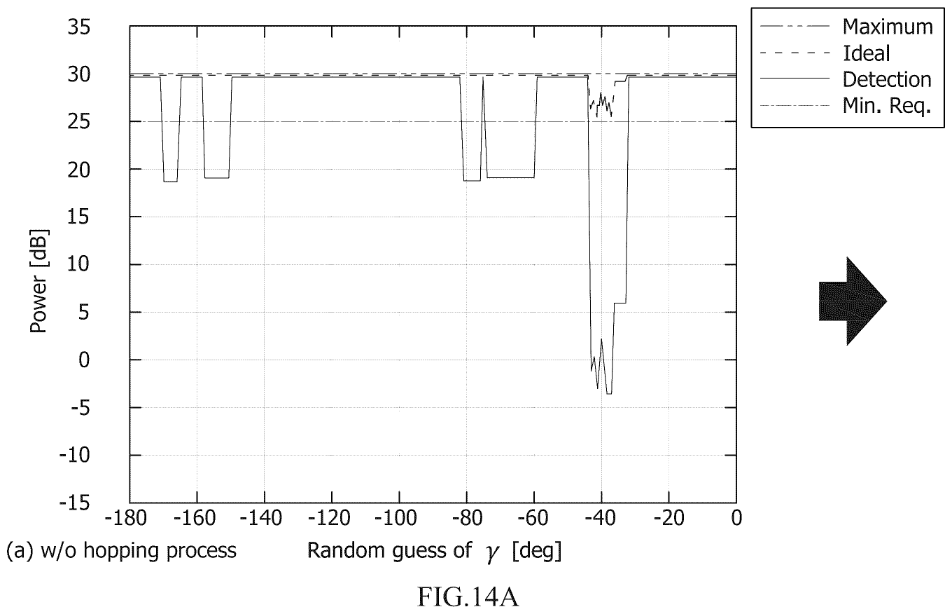

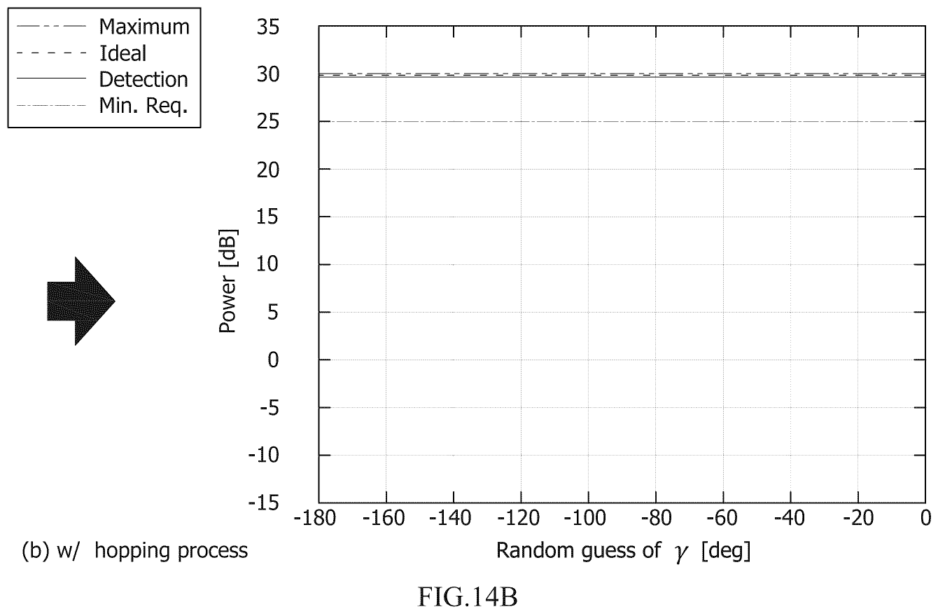

As shown in FIG. 14, Example 5 demonstrates the angular hopping process, with search regions respectively defined as: Θ_{1,1,1}=[3°: 6°: 87°], Θ_{1,2,2}=[−177°: 6°: 177° ], Θ_{1,2,1}=[30°: 3°: 42° ], and Θ_{1,3,2}=[12°: 3°: 24° ]. The initial candidate points are set to \hat{ϑ}_{1,1,1=36}°, and \hat{ϑ}_{1,1,2}=18°. From FIG. 14, it can be seen that the receive (Rx) beamforming output power nearly reaches the maximum value after the angular hopping process.

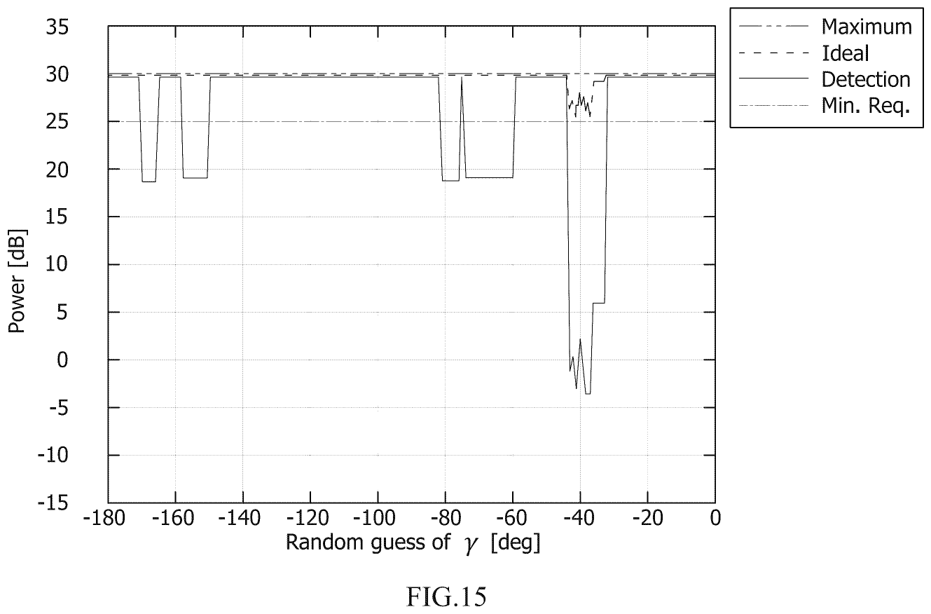

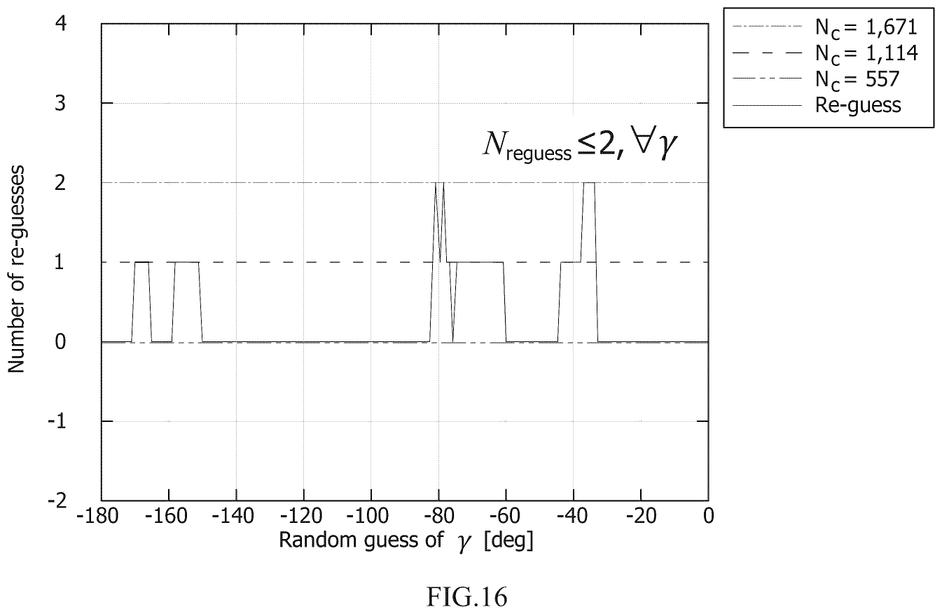

As shown in FIGS. 15 and 16, using the same parameters as in Example 5, Example 6 illustrates the number of re-guesses along the random-guess direction. From FIG. 16, it can be observed that the number of re-guesses is not greater than 2 (N_{reguess}≤2).

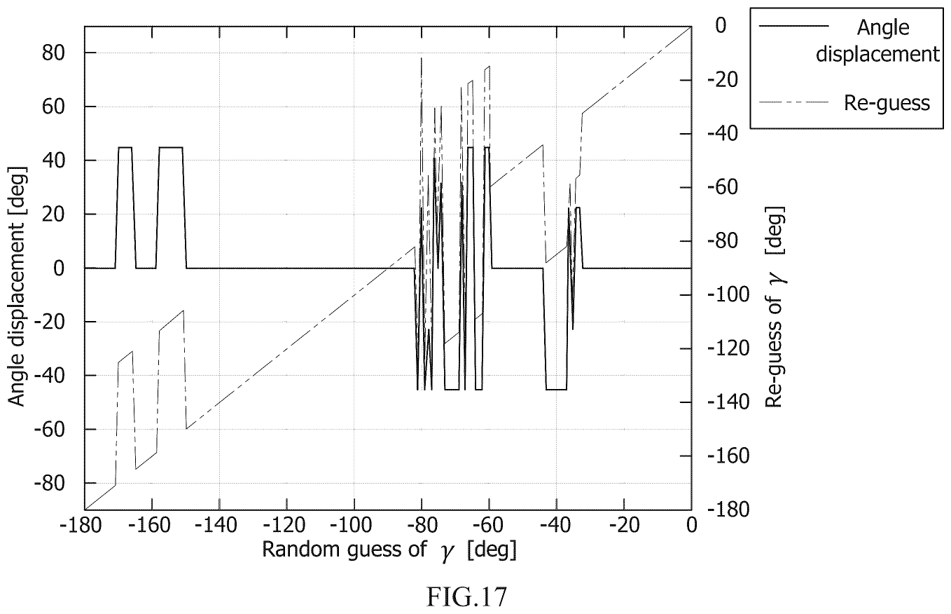

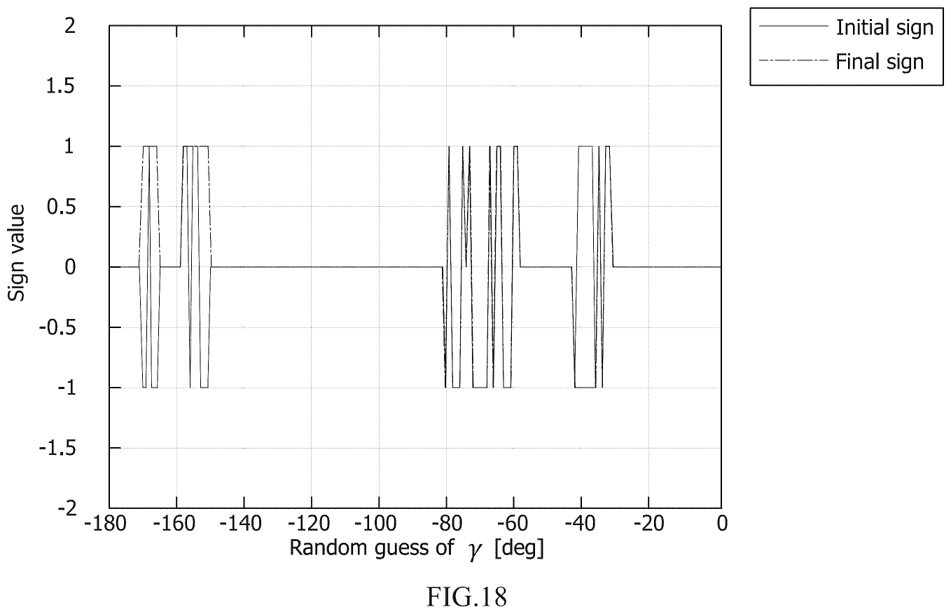

As shown in FIGS. 17 and 18, using the same parameters as in Example 5, Example 7 illustrates the corresponding angular displacement along the random guess direction and the associated random signs in the re-guess process.

Example 8: If the joint/full three-dimensional (3D) search space [symbol] _{F} is decomposed into the retrograded search space [symbol] _{D,1} and the decoupled search space [symbol] _{D,2}, and assuming that the pre-defined search location in the decoupled search space [symbol] _{D,2} is given twice (i.e., re-guess number N_{reguess}=P=2), then the overall search number using the angular hopping process in combination with two-stage peak location detection (PLD) is determined as follows.
1. For the retrograded search space [symbol] _{D,1} (k=1):
   First stage: Θ_{1,1,1}=360°, Θ_{1,1,2}=90°, Δϑ_{1,1,1}=Δϑ_{1,1,2}=6°, candidate number N_{1,1,1}N_{1,1,2}=976.
   Second stage: Θ_{1,2,1}=2Δϑ_{1,1,1}=12°, Θ_{1,2,2}=2Δϑ_{1,1,2}=12°, Δϑ_{1,2,1}=Δϑ_{1,2,2}=3°, candidate number N_{1,2,1}N_{1,2,2}=25.
2. For the decoupled search space [symbol] _{D,2} (k=2):
   First stage: Θ_{2,1,1}=180°, Δϑ_{2,1,1}=6°, candidate number N_{2,1,1}=31.
   Second stage: Θ_{2,2,1}=2Δϑ_{2,1,1}=12°, Δϑ_{2,2,1}=3°, candidate number N_{2,2,1}=5.

The overall search number N_{C} is calculated as:

$${N}_{C} = ( P + 1 ) [ ( {N}_{1 , 1 , 1} {N}_{1 , 1 , 2} ) + ( {N}_{1 , 2 , 1} {N}_{1 , 2 , 2} ) ] + ( {N}_{2 , 1 , 1} ) + ( {N}_{2 , 2 , 1} ) = 3 , 039 ,$$

where,
P=2, and the search range is defined as [N_{C,min}, N_{C,max}]=[1037,3039].

The search efficiency ratios compared to the exhaustive uniform search with two-stage peak location detection (PLD) and the optimal exhaustive uniform search are calculated as follows:

$$R = \frac{{N}_{C , Subopt}}{{N}_{C , F \_ Ts}} = \frac{3 , 039}{30 , 381} \approx 10 \% ; R = \frac{{N}_{C , Subopt}}{{N}_{C , Opt}} = \frac{3 , 039}{228 , 811} \approx 1.3 \% .$$

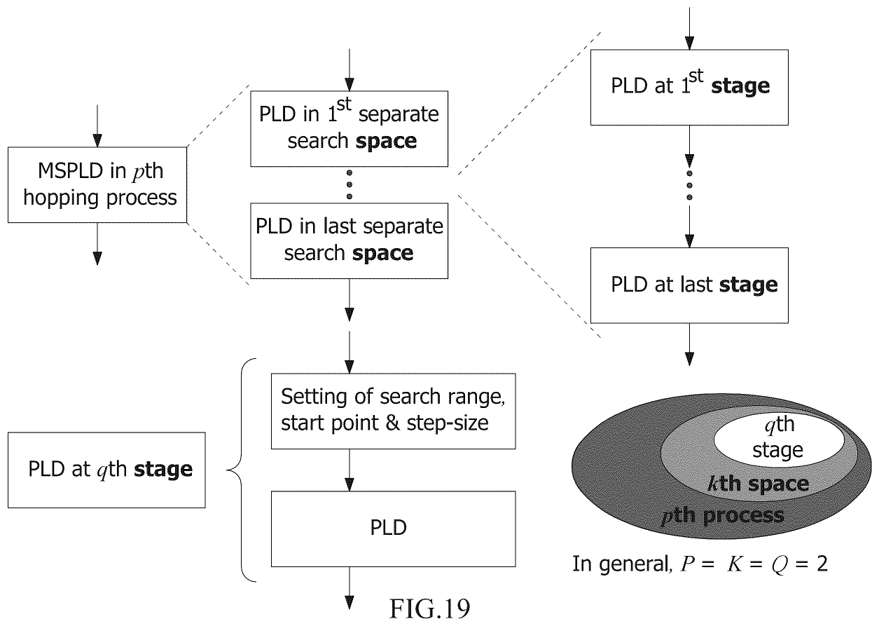

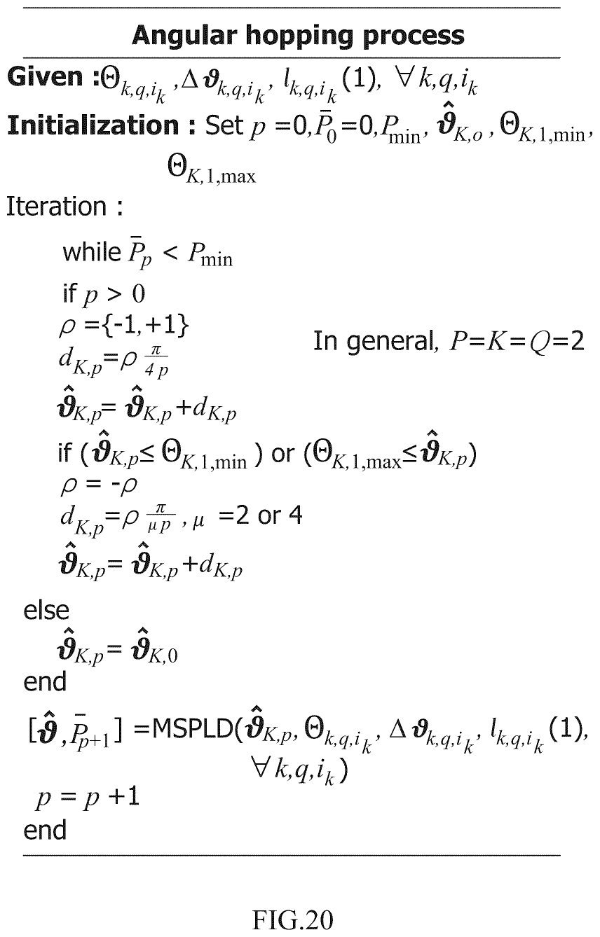

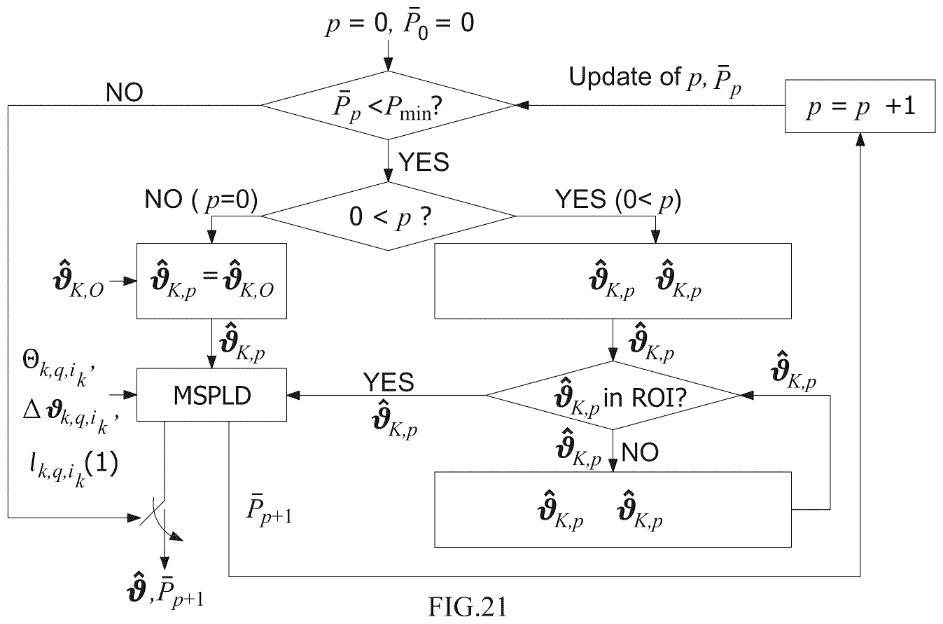

FIG. 19 shows the multi-stage peak location detection procedure in the p^{th} hopping process, which includes: executing peak location detection in different independent search spaces, executing peak location detection in different stages, and setting the search range, starting point, and step size. The figure also illustrates the correspondence between the q^{th} stage, the k^{th} search space, and the p^{th} process, where generally P=K=Q=2. The blank areas shown inside the k^{th} search space in FIG. 19 represent the peak location detection performed in the q^{th} stage. As shown in FIG. 20, the algorithm of the angular hopping process of the present invention includes two parts: conditional judgment and loop control. In the algorithm flow, the first end corresponds to the termination of the conditional judgment structure, i.e., after determining whether the hopping number p is greater than zero, regardless of whether p=0 or p>0, the angle position \hat{ϑ}_{K,p} is updated and the execution of the conditional branch ends. The second end corresponds to the termination of the loop structure, i.e., when the loop condition P̅ₚ<Pₘᵢₙ is no longer satisfied, the loop exits, indicating the end of the angular hopping process and completion of the overall multi-stage peak location detection procedure. Through the design of these two hierarchical termination points, the process ensures that the angle position can be correctly updated under all conditions, and the algorithm flow terminates when the minimum power requirement is satisfied. As shown in FIG. 21, the flowchart of the angular hopping process includes operations such as: determining whether the current output power is below the minimum power requirement; deciding whether to perform angular displacement correction in a random direction based on the iteration number; checking whether the peak location falls within the search region and performing reverse correction if it does not; executing multi-stage peak location detection after the condition is satisfied; and updating the hopping number until the output power reaches the minimum requirement.

### APPENDIX: ARRAY INDEX MAPPING

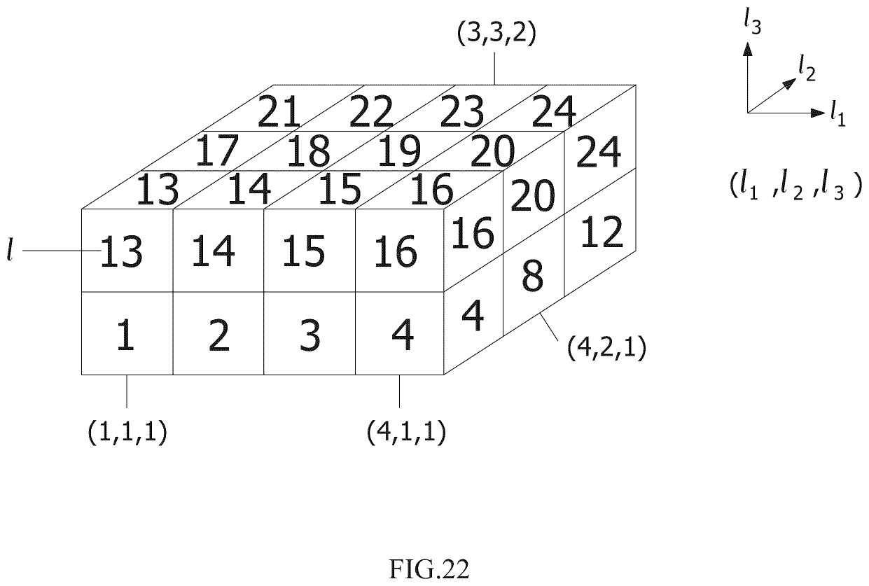

The array index mapping, as shown in FIG. 22, is a schematic diagram illustrating the conversion (mapping) between one-dimensional (1D) and three-dimensional (3D) indices. This mapping is established based on the following relational expressions.

Definition:

$${\{ \tilde{ϑ} \}}_{l} ≡ {[ {\{ {\tilde{ϑ}}_{1} \}}_{{l}_{1}} , {\{ {\tilde{ϑ}}_{2} \}}_{{l}_{2}} , {\{ {\tilde{ϑ}}_{3} \}}_{{l}_{3}} ]}^{T} ∈ {ℝ}^{3} ,$$

l=1, . . . , N_{F}, lᵢ=1, . . . Nᵢ, i=1,2,3. From this, the mapping from a three-dimensional (3D) index to a one-dimensional (1D) index can be established as:
l=map((l₁, l₂, l₃)), which represents the mapping from the three-dimensional (3D) index (l₁, l₂, l₃) to the corresponding one-dimensional (1D) index l; and
(l₁, l₂, l₃)=map(l), which represents the mapping from the one-dimensional (1D) index l to the corresponding three-dimensional (3D) index (l₁, l₂, l₃).

### Example 1: Converting 3D Indices to 1D Index

Given the three-dimensional coordinates (x,y,z)=(2,3,2), and the lengths in the x, y, and z directions respectively as Mₓ, M_{y}, M_{z}, the corresponding one-dimensional (1D) index i is:

$$i = x + {M}_{x} ( ( y - 1 ) + {M}_{y} ( z - 1 ) ) = 2 + 3 ( ( 3 - 1 ) + 3 ( 2 - 1 ) ) = 17 .$$

### Example 2: Converting 1D Index to 3D Indices

Given the one-dimensional (1D) index i=17, and the lengths in the x, y, and z directions respectively as (Mₓ, M_{y}, M_{z})=(3,3,2), the corresponding three-dimensional (3D) index (x,y,z) is:

$$z = ⌈ \frac{i}{{M}_{x} {M}_{y}} ⌉ = ⌈ \frac{17}{9} ⌉ = 2 ,$$

$$y = ⌈ \frac{i - ( z - 1 ) {M}_{x} {M}_{y}}{{M}_{x}} ⌉ = ⌈ \frac{17 - ( 2 - 1 ) 9}{3} ⌉ = 3 ,$$

$$x = i - {M}_{x} ( ( y - 1 ) + {M}_{y} ( z - 1 ) ) = 17 - 3 ( ( 3 - 1 ) + 3 ( 2 - 1 ) ) = 2 .$$

### Example 3: Converting 2D Indices to 1D Index

Given (x, y)=(2,3), (Mₓ, M_{y})=(3,3), and z=M_{z}=1, the corresponding one-dimensional (1D) index i is:

$$i = x + {N}_{x} ( ( y - 1 ) + {N}_{y} ( z - 1 ) ) = 2 + 3 ( ( 3 - 1 ) + 3 ( 1 - 1 ) ) = 8 .$$

### Example 4: Converting 1D Index to 2D Indices

Given i=8, (Mₓ, M_{y})=(3,3), and z=M_{z}=1, the corresponding two-dimensional (2D) index (x, y) is:

$$y = ⌈ \frac{i}{{M}_{x}} ⌉ = ⌈ \frac{8}{3} ⌉ = 3 , x = i - {M}_{x} ( ( y - 1 ) ) = 8 - 3 ( ( 3 - 1 ) ) = 2 .$$

By performing spatial decoupling on the joint/full three-dimensional (3D) search space, separating a one-dimensional (1D) search space with relatively low spatial selectivity as the decoupled search space, and using the remaining two-dimensional (2D) space as the retrograded search space, the present invention can effectively reduce the search dimension and the total number of candidate point detections, thereby reducing computational complexity and search time.

Furthermore, at the start of each stage of the multi-stage peak location detection (MSPLD), the present invention assigns a peak location in the decoupled search space. During the detection process, the assigned peak location is iteratively refined through angular hopping using decreasing angular displacements with random signs. This approach prevents power dead-zone problems during the peak location detection process, thereby improving the accuracy and reliability of detection.

When the beamforming output power falls below the minimum power requirement during the initial search phase, the present invention re-executes the multi-stage peak location detection to ensure that the search process achieves the minimum threshold power required for link alignment, thereby enhancing overall system performance and connection stability.

In summary, the present invention can accomplish the complete search and alignment process with only a limited number of angular hopping processes (typically no more than two), thereby effectively shortening search time, reducing computational burden, avoiding power dead zones, and improving the precision and reliability of antenna beam alignment in Geosynchronous Earth Orbit (GEO) systems.

What is claimed is:

1. An angular hopping method for initial searches in Geosynchronous Earth Orbit (GEO) systems, comprising:
spatial decoupling, which includes decomposing a joint/full three-dimensional (3D) search space into a retrograded search space and a decoupled search space, wherein the decoupled search space comprises a one-dimensional (1D) search space decoupled from the joint/full three-dimensional (3D) search space, and the retrograded search space comprises a two-dimensional (2D) joint search space remaining after spatial decoupling of the joint/full three-dimensional (3D) search space;
multi-stage peak location detection, which includes assigning a peak location in the decoupled search space at the start of each stage of the multi-stage peak location detection; and
angular hopping, which includes iteratively refining a preset peak location by angular displacement in the decoupled search space;
wherein, when a beamforming output power is less than a minimum power requirement of an initial search phase, the multi-stage peak location detection is re-executed.

2. The angular hopping method for initial searches in Geosynchronous Earth Orbit systems according to claim 1, wherein the decoupled search space comprises the one-dimensional (1D) search space having relatively low spatial selectivity.

3. The angular hopping method for initial searches in Geosynchronous Earth Orbit systems according to claim 1, wherein the angular displacement is iteratively corrected with a decreasing displacement distance of random signs.

4. The angular hopping method for initial searches in Geosynchronous Earth Orbit systems according to claim 1, wherein, in a p^{th} process, an angular displacement from a current selected position is expressed as:
$${d}_{K , p} = \pm \frac{π}{μ p} ∈ {Θ}_{K , 1} ,$$
where μ=2 or 4, and p=1, . . . , P;
wherein d_{K,p} represents the angular displacement, and P represents a total number of re-guess processes.

5. The angular hopping method for initial searches in Geosynchronous Earth Orbit systems according to claim 4, wherein P≤2.

6. The angular hopping method for initial searches in Geosynchronous Earth Orbit systems according to claim 3, wherein, in a p^{th} process, an angular displacement from a current selected position is expressed as:
$${d}_{K , p} = \pm \frac{π}{μ p} ∈ {θ}_{K , 1} ,$$
wherein d_{K,p} represents the angular displacement, and P represents a total number of re-guess processes.

7. The angular hopping method for initial searches in Geosynchronous Earth Orbit systems according to claim 6, wherein P≤2.

8. The angular hopping method for initial searches in Geosynchronous Earth Orbit systems according to claim 1, wherein a total number of candidate point detections required in the multi-stage peak location detection process is calculated as follows:
$${N}_{C} = {\sum }_{k = 1}^{K} {N}_{D , k} = {\sum }_{k = 1}^{K} {\underbrace{{\sum }_{q = 1}^{{Q}_{k}} {N}_{D , k , q}}}_{{N}_{D , k}} = {\sum }_{k = 1}^{K} {\sum }_{q = 1}^{{Q}_{k}} {\underbrace{{\prod }_{{i}_{k}}^{{D}_{k}} {N}_{k , q , {i}_{k}}}}_{{N}_{D , k , q}} ,$$
wherein N_{D,k} represents a total number of candidate point detections in a k^{th} independent search space [symbol] _{D,k};
N_{D,k,q} represents a total number of candidate point detections in a q^{th} stage of the k^{th} independent search space [symbol] _{D,k}; and
N_{k,q,i}_{ₖ} represents a number of candidate point detections along an iₖ^{th} search direction in the q^{th} stage of the k^{th} independent search space [symbol] _{D,k}, determined by a scanning region and a step size Δϑ_{k,q,i}_{ₖ}.

9. The angular hopping method for initial searches in Geosynchronous Earth Orbit systems according to claim 1, wherein the multi-stage peak location detection comprises a first stage and a second stage,
wherein the first stage uses a fixed and relatively large step size in the retrograded search space and the decoupled search space for large-scale global search, and
the second stage uses a fixed and relatively small step size in the retrograded search space and the decoupled search space for small-scale local search.

10. The angular hopping method for initial searches in Geosynchronous Earth Orbit systems according to claim 1, wherein the minimum power requirement is defined as a threshold sufficient to achieve beamforming output power required to establish link alignment.
